(19) United States
(12) Patent Application Publication
(10) Pub. No.: US 2012/0188273 A1
(43) Pub. Date: Jul. 26, 2012

(54) METHODS, APPARATUSES AND COMPUTER-READABLE STORAGE MEDIA FOR REPRODUCING IMAGES

(75) Inventors: Hyo-sang Bang, Seoul (KR); Jung-ah Seung, Guri-si (KR)

(73) Assignee: Samsung Electronics Co., Ltd., Suwon-si (KR)

(21) Appl. No.: 13/195,185

(22) Filed: Aug. 1, 2011

(30) Foreign Application Priority Data
Jan. 24, 2011 (KR) 10-2011-0006815

(51) Int. Cl. G09G 5/00

(52) U.S. Cl. 345/629

(57) ABSTRACT

Example methods, apparatuses and computer-readable media for reproducing images are disclosed. A disclosed example method includes reproducing a first image, recognizing a first location of a main object in the first image, recognizing a second location of a main object in a second image, and reproducing the second image so that the main object in the second image is displayed at substantially the first location of the main object in the first image.

### CROSS-REFERENCE TO RELATED PATENT APPLICATION

This application claims the priority benefit of Korean Patent Application No. 10-2011-0006815, filed on Jan. 24, 2011, in the Korean Intellectual Property Office, the entirety of which is incorporated herein by reference.

### BACKGROUND

1. Field of the Invention

The present disclosure relates to methods, apparatuses and computer-readable storage media for reproducing images.

2. Description of the Related Art

A function of reproducing an image is included in various apparatuses such as mobile phones, digital cameras, computers, and the like. An image may include certain objects such as faces and barcodes. Detecting or recognizing such objects is used in many applications.

### SUMMARY

The present application discloses methods, apparatuses and computer-readable storage media for reproducing images based on a main object.

According to an aspect of the invention, there is provided a method of including: reproducing a first image; recognizing a first location of a main object of the first image; recognizing a second location of a main object of a second image; and reproducing the second image so that the main object of the second image is displayed at substantially the first location of the main object of the first image.

The method may further include: recognizing a first size of the main object of the first image; recognizing a second size of the main object of the second image; and scaling the second image according to the first size of the main object of the first image and the second size of the main object of the second image.

The method may further include: recognizing a third location of the main object in a third image; and reproducing the third image so that the main object in the third image is displayed at substantially the first location of the main object of the first image.

The method may further include: shifting and reproducing the third image so that the main object in the third image is displayed at substantially the second location of the main object in the second image; and reproducing the third image according to a reproducing region.

The method may further include: reproducing the first image so that the main object in the first image is displayed in a user-defined area; and reproducing the second image so that the main object of the second image is displayed in the user-defined area.

The method may further include: reproducing the first image according to a reproducing region; shifting and reproducing the second image so that the main object in the second image is displayed at substantially the first location of the main object in the first image; and reproducing the second image according to the reproducing region.

The method may further include: detecting the main object; grouping images including the main object; and determining the first image and the second image in the group of images comprising the main object.

The main object may be a face, and the method may further include: grouping images comprising the face; and determining the first image and the second image in the group of images.

According to another aspect of the invention, there is provided an apparatus including: an object location recognizer to recognize a main object of a first image and a second image; a reproducing location adjuster to determine a reproducing location of the second image so that the main object of the second image is displayed at substantially a location of the main object of the first image; and an image reproducing unit to reproduce the second image according to the reproducing location of the second image after reproducing the first image.

The apparatus may further include: an object size recognizer to recognize a first size of the main object of the first image and a second size of the main object of the second image; and a scaling unit for scaling the second image according to the first size of the main object of the first image and the second size of the main object of the second image.

The object location recognizer may recognize a second location of the main object of a third image, the reproducing location adjuster is to determine a second reproducing location of the third image so that the main object of the third image is displayed at substantially the location of the main object of the first image, and the image reproducing unit reproduces the third image according to the second reproducing location of the third image after reproducing the second image.

The reproducing location adjuster may determine a second reproducing location of the first image and the reproducing location of the second image so that the main object of the first image and the main object of the second image are displayed substantially in a user-set area, and the image reproducing unit is to display the first image substantially at the second reproducing location of the first image and display the second image substantially at the reproducing location of the second image.

The image reproducing unit may reproduce the first image according to a reproducing region and a shift, to reproduce the second image according to the reproducing location of the second image, and further comprising a readjusting unit to control the second image to be reproduced according to the reproducing region.

The object location recognizer may recognize the main object in a third image, the reproducing location adjuster to determine a third reproducing location of the third image so that the main object in the third image is displayed at substantially the location of the main object of the second image, the image reproducing unit is to shift and reproduce the third image according to the third reproducing location of the third image, and the readjusting unit is to control the third image to be reproduced according to the reproducing region.

The apparatus may further include: an object detector to detect the main object; a grouping unit to group images including the main object; and a reproducing image determining unit to determine the first image and the second image in the group of images comprising the main object.

The main object may be a face, and the apparatus may further include: an object recognizer to recognize a face detected in an image; a grouping unit to group images comprising the face; and a reproducing image determining unit to determine the first image and the second image in the group of images comprising the face.

According to another aspect of the invention, there is provided a Tangible computer-readable storage medium having embodied thereon computer program codes that, when executed, cause a machine to at least: reproduce a first image; recognize a first location of a main object in the first image; recognize a second location of a main object in a second image; and reproduce the second image so that the main object in the second image is displayed at substantially the first location of the main object in the first image.

### BRIEF DESCRIPTION OF THE DRAWINGS

The above and other features and advantages of the invention will become more apparent by describing in detail exemplary embodiments thereof with reference to the attached drawings in which:

FIG. 1 is a block diagram of an apparatus for reproducing images, according to an embodiment of the invention;

FIG. 2 is a block diagram of a digital photographing apparatus, to which an apparatus for reproducing an image may be applied, according to an embodiment of the invention;

FIG. 3 is a flowchart illustrating a method of reproducing images, according to an embodiment of the invention;

FIG. 4 illustrates exemplary images reproduction, according to an embodiment of the invention;

FIG. 5 is a diagram illustrating reproducing images according to an embodiment of the invention;

FIG. 6 is a flowchart illustrating a method of reproducing images, according to another embodiment of the invention;

FIG. 7 is a diagram illustrating reproducing images, according to another embodiment of the invention;

FIG. 8 is a flowchart illustrating a method of reproducing images, according to another embodiment of the invention;

FIG. 9 is a diagram illustrating reproducing images, according to another embodiment of the invention;

FIG. 10 is a flowchart illustrating a method of reproducing images, according to another embodiment of the invention;

FIG. 11 is a diagram illustrating reproducing images, according to another embodiment of the invention;

FIG. 12 is a block diagram of an apparatus for reproducing images, according to another embodiment of the invention;

FIG. 13 is a flowchart illustrating a method of reproducing images, according to another embodiment of the invention; and

FIG. 14 illustrates grouped image files, according to an embodiment of the invention.

### DETAILED DESCRIPTION

The detailed description and the accompanying drawings are provided to facilitate understanding of the disclosed embodiments.

Also, the specification and drawings do not limit the invention or the scope of the invention as defined by the claims.

Hereinafter, embodiments of the invention will be described in detail with reference to the accompanying drawings.

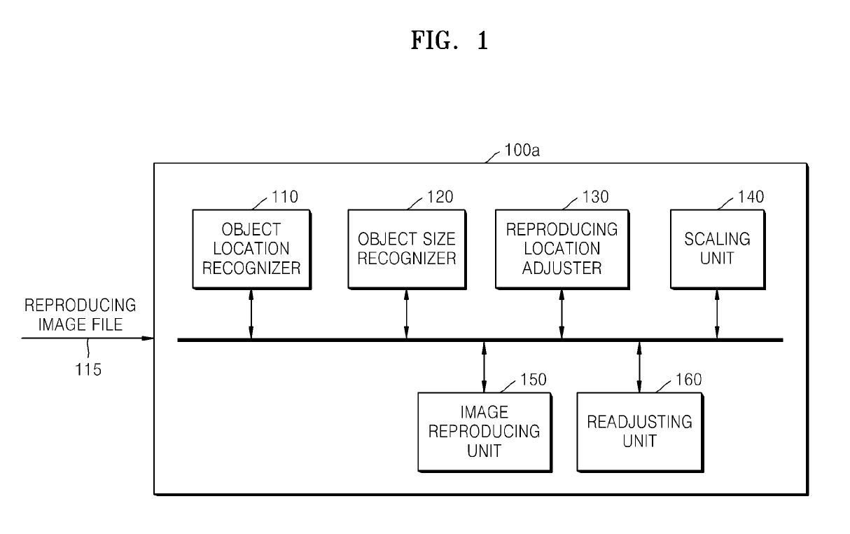

FIG. 1 is a block diagram of an apparatus 100a for reproducing an image, according to an embodiment of the invention.

The apparatus 100a for reproducing an image, according to the current embodiment of the invention, includes an object location recognizer 110, an object size recognizer 120, a reproducing location adjuster 130, a scaling unit 140, an image reproducing unit 150, and a readjusting unit 160.

The object location recognizer 110 recognizes or determines a location of a main object in an image represented by an input reproducing image file 115. For example, the reproducing image file 115 may previously have information about a location of the main object stored in a tag of the reproducing image file 115, and the object location recognizer 110 may recognize the location of the main object using the information about the location of the main object stored in the tag. As another example, the object location recognizer 110 uses an object recognition technique to detect the main object in the image represented by the reproducing image file 115, and determines a location of the main object in the image.

The main object may include various objects such as a face, a barcode, a sign, and the like. In this specification, a face is used as an example main object; however, the invention is not limited thereto.

A location of the main object may be indicated by a box representing a region corresponding to the main object. For example, coordinates at the upper left corner of the box indicating the region corresponding to the main object may be used as the location of the main object, or the center of the box may be used as the location of the main object.

The object size recognizer 120 recognizes or determines a size of the main object. The size of the main object may be indicated by a size of the box indicating the region corresponding to the main object.

The reproducing location adjuster 130 adjusts a reproducing location of a reproduced image according to the location of the main object. According to an embodiment of the invention, when a first image and a second image each including the main object are reproduced, a reproducing location of the second image may be adjusted so that the main object of the second image is displayed at substantially the location of the main object in the first image. In this regard, the reproducing location adjuster 130 calculates a difference between the location of the main object in the first image and the location of the main object in the second image and, thus, outputs an offset for shifting and displaying the second image when reproducing the second image. According to another example of the invention, the reproducing location adjuster 130 may adjust reproducing locations of reproduced images according to a user-configurable setting.

The scaling unit 140 may adjust a size of a reproduced image so that the main object is displayed with a certain size. For example, the scaling unit 140 may expand or reduce a size of the second image according to a size of the main object of the first image so that the main object is displayed with substantially the same size in the first image and the second image.

When the apparatus 100a for reproducing an image, according to the current embodiment of the invention, is applied to a camera, the size of the main object in the first image denotes a size of the main object in a screennail image. Accordingly, the scaling unit 140 may expand or reduce a screennail of the second image according to the size of the main object in the first image in the screennail image. As another example, the scaling unit 140 may expand or reduce the size of the second image using an original image instead of the screennail image. As another example, when the scaling unit 140 reduces the size of the second image, a reproducing image signal for the second image that reduces a size thereof using the screennail image is generated, and when the scaling unit 140 expands the size of the second image, a reproducing image signal for the second image that expands a size thereof using the original image is generated.

The image reproducing unit 150 reproduces the image included in the input reproducing image file 115. The image reproducing unit 150 may reproduce the image included in the reproducing image file 115 according to the reproducing location determined by the reproducing location adjuster 130 and a reproducing size determined by the scaling unit 140. The image reproducing unit 150 may output a display driving signal representing the reproduced image, in which the location and size are adjusted, to a predetermined display driving unit (not illustrated).

The readjusting unit 160 readjusts the reproduced image, in which the reproduced location is shifted by an amount determined by the reproducing location adjuster 130 and/or the reproduced size is changed by an amount determined by the scaling unit 140, according to the location and size of the reproduced image. For example, the readjusting unit 160 may control reproduction of the second image so that the second image is displayed according to the location and size of a reproduced region on a screen with respect to the second image that was displayed at the reproducing location and size adjusted according to the location and size of the main object in the first image.

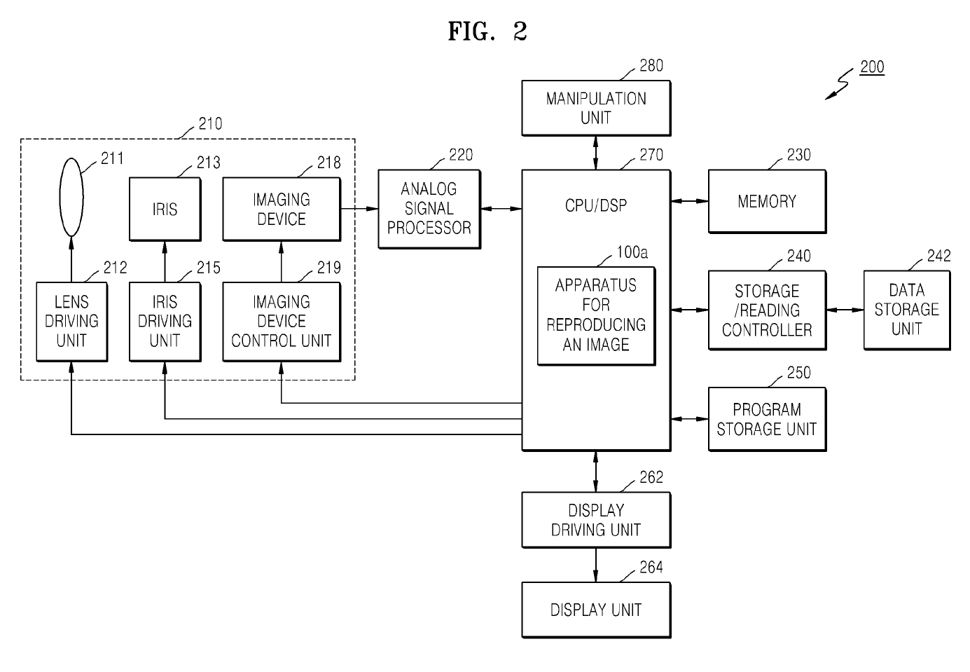

FIG. 2 is a block diagram of a digital photographing apparatus 200, in which the apparatus 100a for reproducing an image may be implemented, according to an embodiment of the invention. The apparatus 100a for reproducing an image may be applied to, for example, the digital photographing apparatus 200 of FIG. 2.

The digital photographing apparatus 200 may include a photographing unit 210, an analog signal processor 220, a memory 230, a storage/reading controller 240, a data storage unit 242, a program storage unit 250, a display driving unit 262, a display unit 264, a CPU/DSP 270, and a manipulation unit 280.

Entire operation of the digital photographing apparatus 200 may be managed by the CPU/DSP 270. The CPU/DSP 270 provides control signals for driving each element of a lens driving unit 212, an iris driving unit 215, and an imaging device control unit 219.

The photographing unit 210 generates an image of an electric signal from incident light and includes a lens 211, the lens driving unit 212, an iris 213, the iris driving unit 215, an imaging device 218, and the imaging device control unit 219.

The lens 211 may include a plurality of groups of or pieces of lenses. A location of the lens 211 is controlled by the lens driving unit 212. The lens driving unit 212 controls the location of the lens 211 according to control signals provided by the CPU/DSP 270.

Opening and closing of the iris 213 is controlled by the iris driving unit 215 and the iris 213 controls an amount of light incident on the imaging device 218.

An optical signal that passes through the lens 211 and the iris 213 forms an image of a subject on a light receiving surface of the imaging device 218. The imaging device 218 may be a charge coupled device (CCD) or a complementary metal oxide semiconductor image sensor (CMOS) that converts an optical signal into an electric signal. Sensitivity of the imaging device 218 may be controlled by the imaging device control unit 219. The imaging device control unit 219 may control the imaging device 218 according to a control signal automatically generated by an image signal input in real time, or a control signal manually input by a user.

Exposure time of the imaging device 218 is controlled using a shutter (not illustrated). The shutter may include a mechanical shutter that controls incident light by moving a screen, or an electric shutter that controls exposure by applying an electric signal.

The analog signal processor 220 may perform a noise reduction process, gain adjusting, waveform shaping, and analog-digital conversion with respect to an analog signal applied from the imaging device 218.

The signal processed by the analog signal processor 220 may be input to the CPU/DSP 270 through the memory 230, or may be input to the CPU/DSP 270 without passing through the memory 230. Here, the memory 230 is implemented as a main memory of the digital photographing apparatus 200 and temporarily stores information needed or used by the CPU/DSP 270. The program storage unit 250 stores programs such as an operating system and an application system used to implement the digital photographing apparatus 200.

In addition, the digital photographing apparatus 200 includes the display unit 264 so as to display an operation state of the digital photographing apparatus 200, or image information captured by the digital photographing apparatus 200. The display unit 264 may provide visible information and/or acoustic information to a user. In order to provide visible information, the display unit 264 may include, for example, a liquid crystal display (LCD) panel, an organic light emitting display (OLED) panel, or the like. Also, the display unit 264 may be a touch screen that may recognize a touch input.

The display driving unit 262 provides a driving signal to the display unit 264.

The CPU/DSP 270 processes an input image signal and controls each element according to the processed signal or an external input signal. The CPU/DSP 270 may reduce noise with respect to input image data and perform image signal processes for image quality improvement such as gamma correction, color filter array interpolation, color matrix, color correction, color enhancement, and the like. Also, the CPU/DSP 270 may generate an image file by compressing the image data generated after image signal processing for image quality improvement, or may restore image data from an image file. For example, a still image may be converted into a joint photographic experts group (JPEG) form or a JPEG 2000 form. Also, when a moving picture is recorded, a plurality of frames may be compressed and a moving picture file may be generated according to a moving picture experts group (MPEG) standard. An image file may be generated according to, for example, an exchangeable image file format (Exif) standard.

Image data output from the CPU/DSP 270 is input directly to the storage/reading controller 240 or to the storage/reading controller 240 through the memory 230, wherein the storage/reading controller 240 stores image data to the data storage unit 242 automatically or according to a signal from a user. Also, the storage/reading controller 240 reads data about an image from the image file stored in the data storage unit 242 and inputs the read data to the display driving unit 262 through the memory 230 or through other paths so that an image may be displayed on the display unit 264. The data storage unit 242 may be user detachable or may be permanently attached to the digital photographing apparatus 200.

Also, in the CPU/DSP 270, an unclearness process, a color process, a blurring process, an edge enhancement, an image analyzing, an image recognizing, and an image effect process may be performed. Image recognizing, face recognizing and scene recognizing may also be performed. In addition, in the CPU/DSP 270, a display image signal process for displaying on the display unit 264 may be performed. For example, brightness level adjusting, color correction, contrast adjusting, edge enhancement adjusting, screen division, characteristic image generating and synthesizing may be performed. The CPU/DSP 270 may be connected to an external monitor and may perform a predetermined image signal process so as to display an image on the external monitor. Also, the CPU/DSP 270 may transmit the processed image data and allow displaying the corresponding image on the external monitor.

In addition, the CPU/DSP 270 executes programs stored in the program storage unit 250 or includes a separate module so as to generate one or more control signals for controlling auto focusing, zoom changing, focus changing, and automatic exposure correction and provides the control signal(s) to the iris driving unit 215, the lens driving unit 212, and the imaging device control unit 219 so as to control overall operation of elements included in the digital photographing apparatus 200 such as the shutter, a flash, and the like.

The apparatus 100a for reproducing an image according to the embodiment of the invention is included in or implemented by the CPU/DSP 270 of the digital photographing apparatus 200 and, thus, may perform operations according to embodiments of the invention. The display unit 264 may display an image according to an image signal generated in the apparatus 100a for reproducing an image.

The manipulation unit 280 may be used by a user to input a control signal. The manipulation unit 280 may include various buttons such as a shutter-release button, a power button, a zoom button, a mode selection button, and other photographing set adjusting buttons. The shutter-release button inputs a shutter-release signal so as to expose the imaging device 218 to light for predetermined time and to take a photograph, the power button inputs a control signal for controlling on/off of a power supply, and the zoom button expands or reduces an optic angle according to an input. The manipulation unit 280 may be realized in any form as long as a user may input a control signal via a button, a keyboard, a touch pad, a touch screen, a remote controller, and the like.

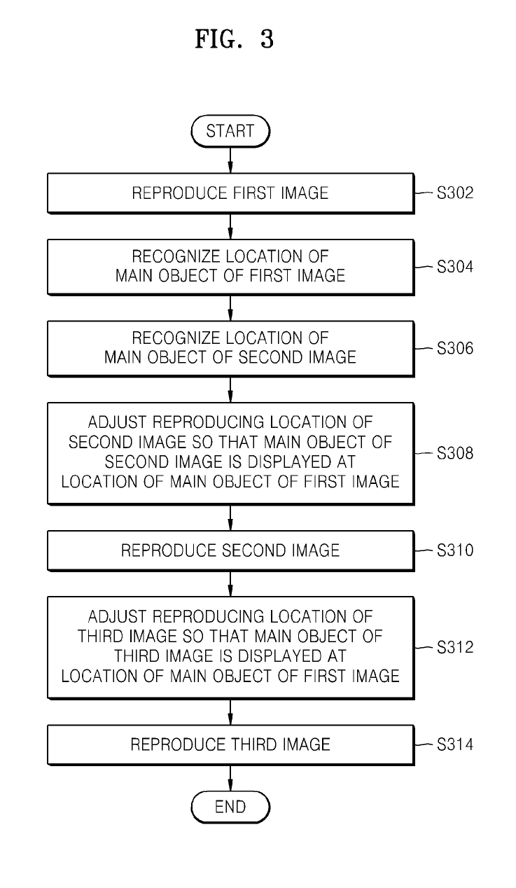

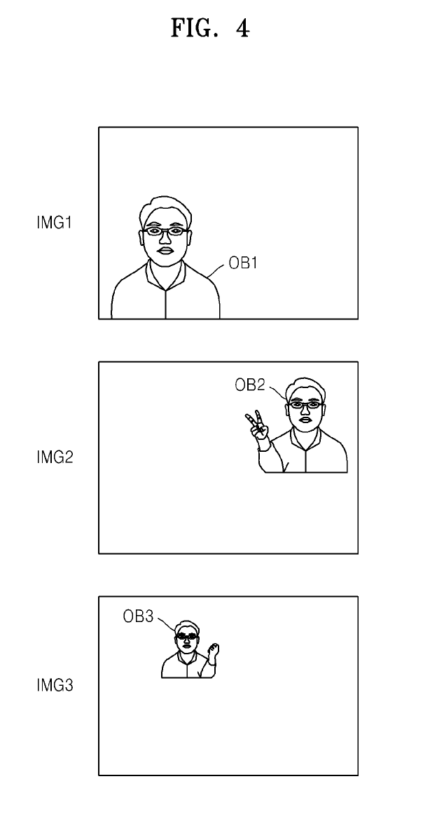

FIG. 3 is a flowchart illustrating a method of reproducing images, according to an embodiment of the invention, and FIG. 4 illustrates exemplary images reproduced according to an embodiment of the invention. The method of reproducing images is described with reference to FIGS. 1 through 4. A first image IMG1, a second image IMG2, and a third image IMG3 are reproduced sequentially in this order.

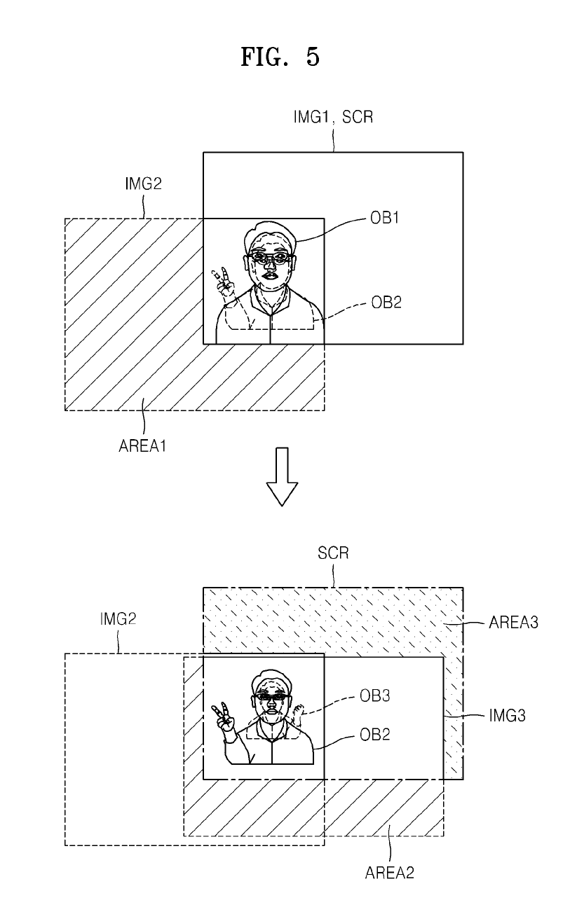

The image reproducing unit 150 reproduces the first image IMG1 included in a first image file 115 input to the apparatus 100a for reproducing, in operation S302. In this regard, the image reproducing unit 150 generates an image signal corresponding to the first image IMG1 and outputs the signal to the display driving unit 262. The first image IMG1 may be displayed according to a reproducing region SCR (FIG. 5). Here, the reproducing region SCR denotes a region defined so that a reproduced image is displayed at the display unit 264 of the digital photographing apparatus 200.

The object location recognizer 110 recognizes a location of a main object OB1 included in the first image IMG1, in operation S304. As described above, the location of the main object OB1 in the first image IMG1 may be recognized by referring to the location of the main object stored in a tag of an image file 115, or detecting and determining the location of the main object OB1 from the first image IMG1. For example, information about a location of a face in the first image IMG may be included in a tag of an image file, and the object location recognizer 110 may recognize the location of the main object OB1 using the information about the location of the face stored in the tag.

When a second image file 115 is input to the apparatus 100a for reproducing an image, a location of a main object OB2 included in the second image IMG2 is recognized, in operation S306. Here, the main object OB1 included in the first image IMG1 and the main object OB2 included in the second image IMG2 are the same type of object. For example, the main objects included in the first image IMG1 and the second image IMG2 are both faces or barcodes.

As another example, the main object OB1 included in the first image IMG1 and the main object OB2 included in the second image IMG2 may be the same object. For example, the main object OB1 included in the first image IMG1 and the main object OB2 included in the second image IMG2 may be the face of the same person. In this embodiment, although the face is included in both the first image IMG1 and the second image IMG2, if the face included in the first image IMG1 and the second image IMG2 is not the face of the same person, the method of reproducing an image according to the current embodiment of the invention may not be applied.

The reproducing location adjuster 130 adjusts a reproducing location of the second image IMG2 so that the main object OB2 in the second image IMG2 is displayed at substantially the location of the main object OB1 in the first image IMG1, in operation S308.

FIG. 5 is a diagram illustrating reproducing images according to an embodiment of the invention.

As illustrated in FIG. 5, the first image IMG1 is reproduced according to the reproducing region SCR, and the second image IMG2 is reproduced after adjusting the reproducing location. In this regard, the reproducing location adjuster 130 obtains or determines a difference between the location of the main object OB1 in the first image IMG1 and the location of the main object OB2 in the second image IMG2 and may adjust the reproducing location of the second image IMG2 so that the main object OB2 in the second image IMG2 is displayed at substantially the location of the main object OB1 in the first image IMG1, according to the difference.

When the reproducing location of the second image IMG2 is adjusted, in operation S308, the image reproducing unit 150 reproduces the second image IMG2, in operation S310 (FIG. 3). The image reproducing unit 150 may provide a fading effect when passing from the first image IMG1 to the second image IMG2. As illustrated in FIG. 5, when the second image IMG2 is reproduced, the second image IMG2 is not matched with the reproducing region SCR, and an image in a region corresponding to AREA1 of the second image IMG2 is not displayed.

The reproducing location adjuster 130 may adjust a reproducing location of a third image IMG3 so that a main object OB3 in the third image IMG3 is displayed at substantially the location of the main object OB1 in the first image IMG1, in operation S312. In this regard, the reproducing location adjuster 130 obtains a difference between the location of the main object OB1 in the first image IMG1 and the location of the main object OB3 in the third image IMG3 and may adjust the reproducing location of the third image IMG3 so that the main object OB3 in the third image IMG3 is displayed at substantially the location of the main object OB1 in the first image IMG1, according to the difference.

When the reproducing location of the third image IMG3 is determined, in operation S312, the image reproducing unit 150 reproduces the third image IMG3, in operation S314. As illustrated in FIG. 5, the third image IMG3 is not matched with the reproducing region SCR and a region corresponding to AREA2 of the third image IMG3 is not displayed. When only the second image IMG2 and the third image IMG3 are reproduced, an area AREA3 where no image is displayed in the reproducing region SCR is generated, and predetermined image, pattern, color may be displayed on AREA3.

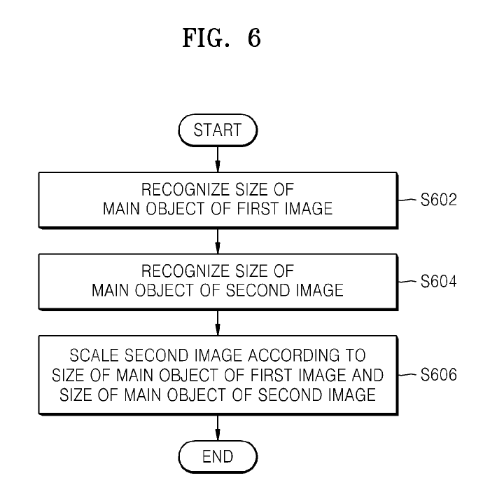

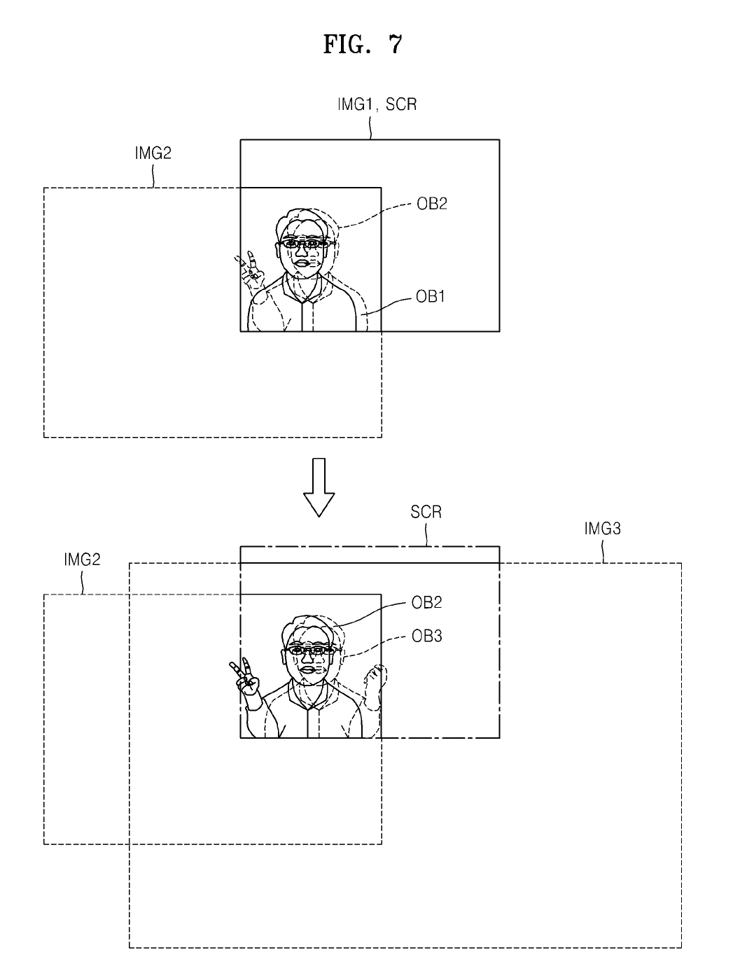

FIG. 6 is a diagram for explaining a method of reproducing images according to another embodiment of the invention, and FIG. 7 is a diagram illustrating reproducing images according to another embodiment of the invention.

In the method of reproducing images, according to the current embodiment of the invention, when an image is reproduced, a reproducing location of a current image is adjusted according to a location of a main object in a previous image and a reproducing size of the current image is scaled according to a size of the main object. Thus, according to the current embodiment, when a plurality of images is reproduced, main objects are displayed with substantially the same size and at substantially the same location.

When a first image file 115 is input, the object size recognizer 120 recognizes a size of the main object OB1 of the first image IMG1, in operation S602. As an example, the size of the main object OB1 may be read from information about the main object OB1 included in the first image file. As another example, the object size recognizer 120 may recognize a size of the main object OB1 using an object detection algorithm.

When a second image file 115 is input, the object size recognizer 120 recognizes a size of the main object OB2 of the second image file IMG2, in operation S604.

The scaling unit 140 compares the size of the main object OB1 of the first image IMG1 with the size of the main object OB2 of the second image IMG2, and scales the second image IMG2 according to the size of the main object OB1 of the first image IMG1, in operation S606. Here, the scaling unit 140 adjusts a reproducing size of the second image IMG2 so that the size of the main object OB2 of the second image IMG2 is substantially the same as the size of the main object OB1 of the first image IMG1.

As illustrated in FIG. 7, the first image IMG1 is displayed by matching the first image IMG1 to the reproducing region SCR and, when the second image IMG2 is displayed, the second image IMG2 is expanded so that the main object OB2 of the second image IMG2 is displayed with substantially the same size as the main object OB1 of the first image IMG1. Accordingly, the second object OB2 of the second image IMG2 that is originally smaller than the main object OB1 of the first image IMG1 is displayed at substantially the same size as or at a size similar to the main object OB1 of the first image IMG1.

When a third image file 115 is input, the object size recognizer 120 recognizes a size of the main object OB3 of the third image IMG3. The scaling unit 140 compares the size of the object OB3 of the third image IMG3 with the size of the main object OB2 of the second image IMG2, and adjusts a reproducing size of the third image IMG3 so that the main object OB3 of the third image IMG3 is displayed at substantially the same size as or at a size similar size to the main object OB2 of the second image IMG2. Here, the second image IMG2 may maintain its expanded size when transitioning from the first image IMG1 to the second image IMG2, or the size of the second image IMG2 may be readjusted so that the second image IMG2 is reproduced to substantially match the reproducing region SCR.

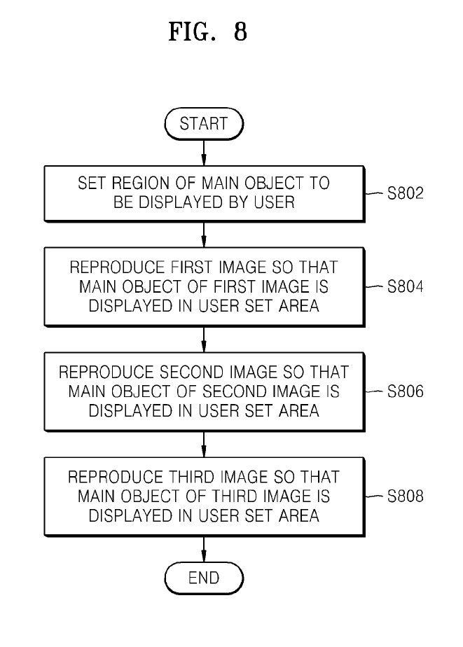

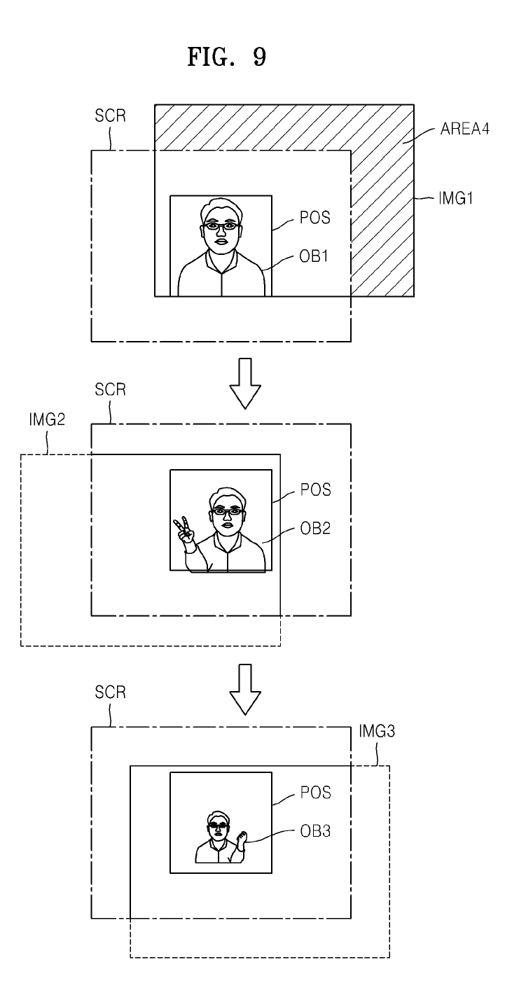

FIG. 8 is a flowchart illustrating a method of reproducing images, according to another embodiment of the invention, and FIG. 9 is a diagram illustrating reproducing images according to another embodiment of the invention.

According to the current embodiment of the invention, a user previously selected a location of a main objet to be displayed, and main objects included in images may be always displayed in a region set by the user.

A user designates a location of a main object to be displayed in the reproducing region SCR, in operation S802. In FIG. 9, a user-set area POS is designated at the center of the reproducing region SCR.

When a first image file 115 is reproduced, the reproducing location adjuster 130 adjusts a reproducing location of the first image IMG1 so that the main object OB1 of the first image IMG1 is displayed in the user set area POS, and the image reproducing unit 150 displays the first image IMG1 at a corresponding location, in operation S804. In FIG. 9, the first image IMG1 does not match the reproducing region SCR and the main object OB1 of the first image IMG1 is displayed at the user set area POS. In the reproducing region SCR, a region AREA4 other than the region displaying the first image IMG1 may be filled with predetermined pattern, color, and background.

When a second image file 115 is input, the reproducing location adjuster 130 adjusts a reproducing location of the second image IMG2 so that the main object OB2 in the second image IMG2 is displayed in the user set area POS, and the image reproducing unit 150 displays the second image IMG2 at a corresponding location, in operation S806. In FIG. 9, the reproducing location of the second image IMG2 is adjusted so that the main object OB2 of the second image IMG2 is substantially displayed in the user set area POS.

When a third file 115 is input, the reproducing location adjuster 130 adjusts a reproducing location of the third image IMG3 so that the main object OB3 of the third image IMG3 is displayed in the user set area POS, and the image reproducing unit 150 displays the third image IMG3 at a corresponding location, in operation S808. In FIG. 9, the reproducing location of the third image IMG3 is adjusted so that the main object OB3 of the third image IMG3 is substantially displayed in the user set area POS.

In the current embodiment of the invention, a location of the main object is fixed to the user-set area POS and a size of the main object may be adjusted according to the size of the user-set area POS. In the current embodiment of the invention, a reproducing size of an image is adjusted according to a size of the user-set area POS in the scaling unit 140 and the image reproducing unit 150 reproduces an image having an adjusted size.

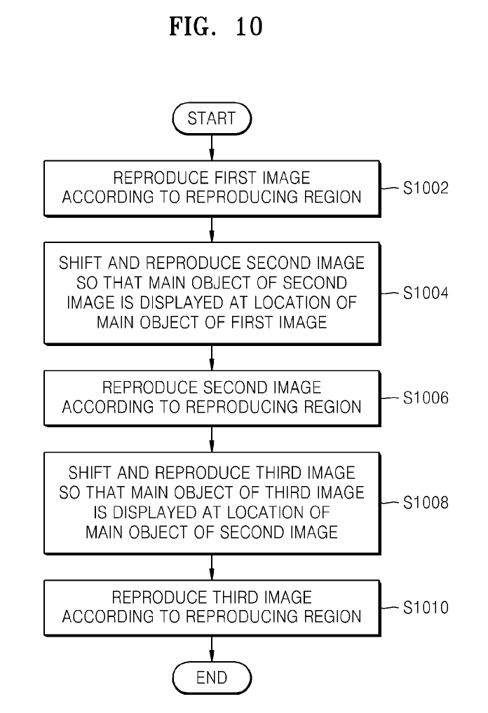

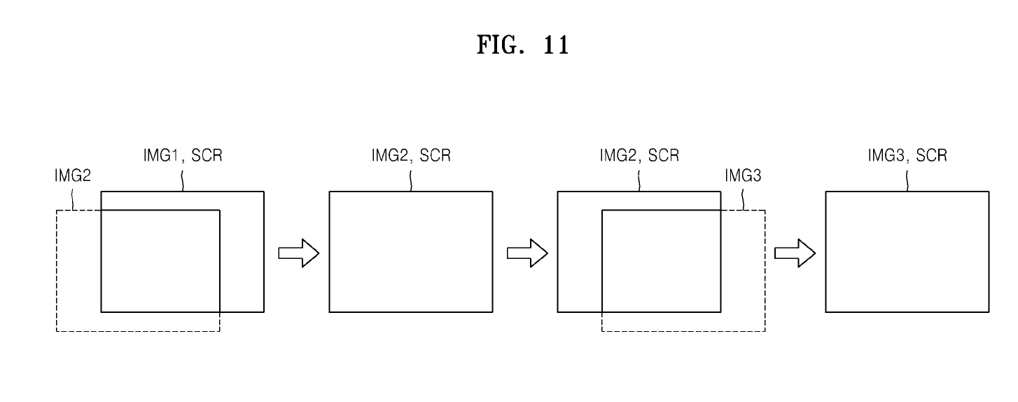

FIG. 10 is a flowchart illustrating a method of reproducing images, according to another embodiment of the invention, and FIG. 11 is a diagram illustrating reproducing images according to another embodiment of the invention.

According to the current embodiment of the invention, a reproducing location and/or size of the second image IMG2 is adjusted and displayed so that the reproducing location and/or size of the second image IMG2 is fixed according to the location and/or size of the main object OB1 in the first image IMG1, and the reproducing location and/or size of the second image IMG2 is readjusted to be displayed according to the reproducing region SCR before reproducing the third image IMG3.

The image reproducing unit 150 reproduces the first image IMG1 according to the reproducing region SCR, in operation S1002.

When a second image file 115 is input, the second image IMG2 is shifted and reproduced, in operation S1004, so that the main object OB2 of the second image IMG2 is displayed at substantially the location of the main object OB1 of the first image IMG1. In this regard, the object location recognizer 110 recognizes the locations of the main object OB1 of the first image IMG1 and the main object OB2 of the second image IMG2, and the reproducing location adjuster 130 shifts the reproducing location of the second image IMG2 so that the main object OB2 of the second image IMG2 is displayed at substantially the location of the main object OB1 of the first image IMG1. In FIG. 11, the second image IMG2 is shifted and displayed, thus, does not match the reproducing region SCR. Here, the second image IMG2 may be reproduced by adjusting the reproducing size determined by the scaling unit 140 so that the main object OB2 may be displayed at substantially the same size as the main object OB1 of the first image IMG1.

The reproducing location of the second image IMG2 is readjusted and, thus, the second image IMG2 is displayed according to the reproducing region SCR, in operation S1006. In this regard, as illustrated in FIG. 11, the readjusting unit 160 readjusts the reproducing location of the second image IMG2 and fixes the reproducing location of the second image IMG2 to substantially correspond to the reproducing region SCR.

When a third image file 115 is input, the third image IMG3 is shifted and reproduced so that the main object OB3 of the third image IMG3 is displayed at substantially the location of the main object OB2 of the second image IMG2, in operation S1008. In this regard, the object location recognizer 110 recognizes the locations of the main object OB2 of the second image IMG2 and the main object OB3 of the third image IMG3, and the reproducing location adjuster 130 shifts the reproducing location of the third image IMG3 so that the main object OB3 of the third image IMG3 is displayed at substantially the location of the main object OB2 of the second image IMG2. In FIG. 11, the third image IMG3 is shifted and displayed, thus, does not match the reproducing region SCR. Here, the third image IMG3 may be reproduced by adjusting the reproducing size by an amount determined by the scaling unit 140 so that the main object OB3 may be displayed at substantially the same size with the main object OB2 of the second image IMG2.

The reproducing location of the third image IMG3 is readjusted and, thus, the third image IMG3 is displayed substantially according to the reproducing region SCR, in operation S1010. In this regard, as illustrated in FIG. 11, the readjusting unit 160 readjusts the reproducing location of the third image IMG3 and fixes the reproducing location of the third image IMG3 to the reproducing region SCR.

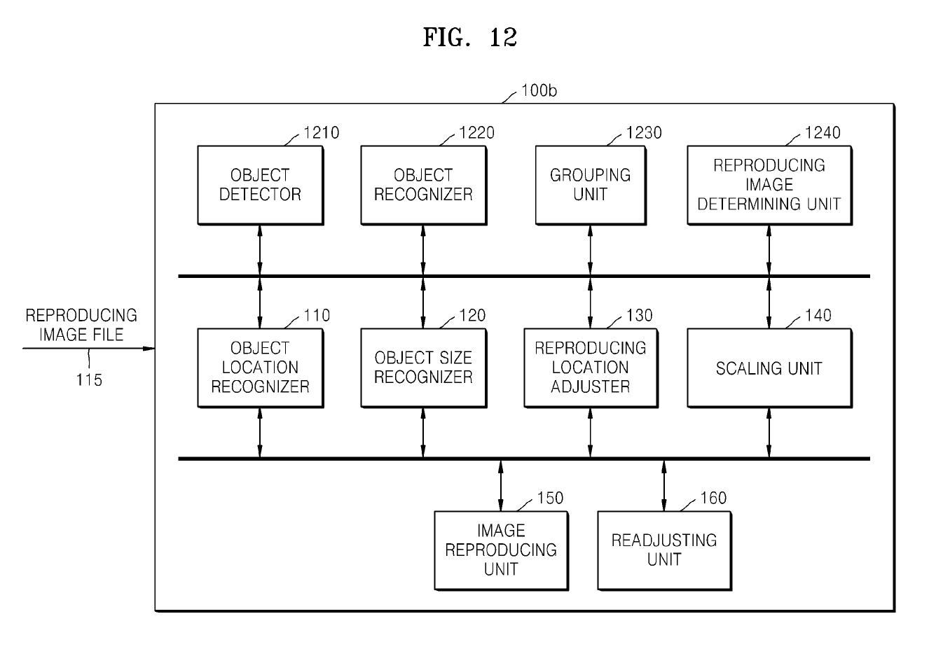

FIG. 12 is a block diagram of an apparatus 100b for reproducing images, according to another embodiment of the invention.

The apparatus 100b for reproducing an image, according to the current embodiment of the invention, may include the object location recognizer 110, the object size recognizer 120, the reproducing location adjuster 130, the scaling unit 140, the image reproducing unit 150, the readjusting unit 160, an object detector 1210, an object recognizer 1220, a grouping unit 1230, and a reproducing image determining unit 1240.

According to the current embodiment of the invention, image files are grouped according to characteristics of objects, and when the image files are reproduced, the image files in the same group or in a plurality of groups may be reproduced. Also, in the current embodiment of the invention, in the digital photographing apparatus 200, a captured image may be generated, and when an image file 115 for the captured image is generated, objects included in the captured image are detected and/or recognized, and are grouped so that information about the objects and information about the group may be written to the image file.

The object detector 1210 detects a predetermined object in an image included in an image file 115. For example, the object detector 1210 detects objects of predetermined kinds such as faces, barcodes, and signs from an input image. In this regard, the object detector 1210 may use various object detection algorithms. Also, the object detector 1210 may store the detected location, size, and kind of the object to the image file 115, to which the corresponding image is stored.

The object recognizer 1220 identifies the detected object and recognizes the object. For example, the object recognizer 1220 may recognize and identify the face detected in the image. In order to recognize the face, the object recognizer 1220 may use a face recognition algorithm such as, for example, an adaptive boosting (Adaboost) algorithm. Also, the object recognizer 1220 may store face recognition information in the image file 115, to which the corresponding image is stored.

The grouping unit 1230 groups image files 115 based in the information about the objects generated in the object recognizer 1220.

The grouping unit 1230 may group image files 115 including the same kind of objects according to object detection results into one group. For example, the grouping unit 1230 may group image files 115 including a face into one group.

As another example, according to object recognition results by the object recognizer 1220, the grouping unit 1230 may group image files 115 including the same object into one group. For example, the grouping unit 1230 designates image files 115 including the face of person A as one group, and image files 115 including the face of person B as the other group.

The reproducing image determining unit 1240 may determine reproducing of images according to the groups determined by the grouping unit 1230. The reproducing image determining unit 1240 may determine that only image files 115 in the same group are reproduced, or to reproduce image files 115 in a plurality of designated groups. As an example, the reproducing image determining unit 1240 may determine that a group of image files 115 including faces is reproduced. As another example, the reproducing image determining unit 1240 may determine that image files 115 included in group corresponding to person A and a group corresponding to person B are reproduced.

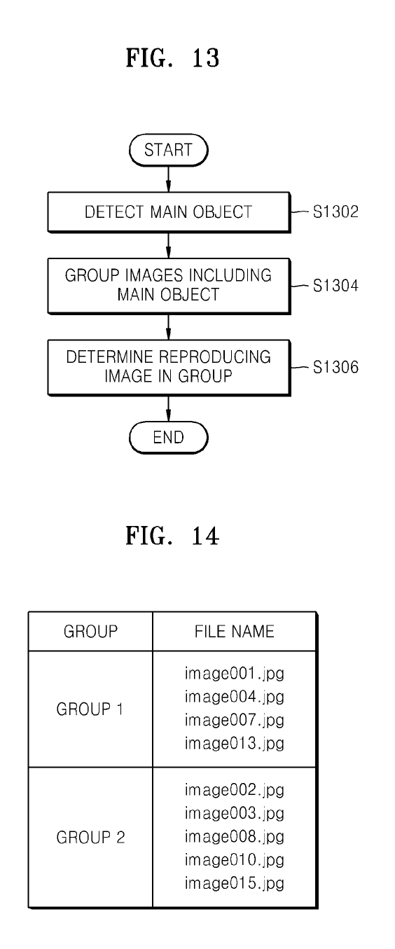

FIG. 13 is a flowchart illustrating a method of reproducing images, according to another embodiment of the invention.

The object detector 1210 detects a main object in an input image, in operation S1302. The main object may be recognized by the object recognizer 1220. The main object may be designated by a user or may be previously set. For example, a user may designate a face as a main object. As another example, a user may designate a face of person A as a main object. As another example, a main object may be previously set as a face.

The grouping unit 1230 groups image files 115 including the main object, in operation S1304. In this regard, the grouping unit 1230 may refer to information about the objects drawn from the object detector 1210 and the object recognizer 1220.

FIG. 14 illustrates grouped image files 115.

As illustrated in FIG. 14, image files 115 may be grouped according to predetermined criteria. The grouping unit 1230 may generate grouping information in a virtual table form. As another example, the grouping unit 1230 writes grouping information to tags of each file 115 and then may search and use the group information written to the tags of each image file 115 in the reproducing image determining unit 1240.

As described above, grouping may be performed in various ways. As an example, in FIG. 14, the image files are grouped according to object detection information so that GROUP 1 indicates image files 115 including faces and GROUP 2 indicates image files 115 including barcodes. As another example, image files 115 are grouped according to object detection information so that GROUP 1 may indicate image files 115 including the face of person A and GROUP 2 may indicate image files 115 including the face of person B.

The reproducing image determining unit 1240 determines a reproducing image using the grouping information, in operation S1306. The reproducing image determining unit 1240 may determine image files included in the same group for reproduction, or may designate a plurality of groups for reproduction.

According to the embodiments of the invention, images may be reproduced mainly based on main objects, thereby increasing user convenience.

The disclosed embodiments can be embodied as computer-readable codes on a tangible or non-transitory computer-readable storage medium. The computer-readable storage medium may be any data storage device that can store data that can be thereafter read by a computer system. As used herein, a computer-readable storage medium excludes any computer-readable media on which signals may be propagated. However, a computer-readable storage medium may include internal signal traces and/or internal signal paths carrying electrical signals therein

The computer-readable codes, when executed, cause a machine to at least execute operations of a method of reproducing images, according to the invention. For example, the computer-readable codes may be read and executed by the CPU/DSP 270 from the computer-readable storage medium. The computer-readable codes may be realized with various programming languages. Also, functional programs, codes, and code segments for accomplishing the invention can be easily construed by programmers skilled in the art to which the invention pertains. Examples of the computer-readable storage medium include a read-only memory (ROM), a random-access memory (RAM), a compact disc (CD), a digital versatile disc (DVD), magnetic tapes, floppy disks, and optical data storage devices. The computer-readable recording medium can also be distributed over network coupled computer systems so that the computer-readable codes may be stored and executed in a distributed fashion.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A method comprising:
reproducing a first image;
recognizing a first location of a main object in the first image;
recognizing a second location of the main object in a second image; and
reproducing the second image so that the main object in the second image is displayed at substantially the first location of the main object in the first image.

2. The method of claim 1, further comprising:
recognizing a first size of the main object of the first image;
recognizing a second size of the main object of the second image; and
scaling the second image according to the first size of the main object of the first image and the second size of the main object of the second image.

3. The method of claim 1, further comprising:
recognizing a third location of the main object in a third image; and
reproducing the third image so that the main object in the third image is displayed at substantially the first location of the main object of the first image.

4. The method of claim 3, further comprising:
shifting and reproducing the third image so that the main object in the third image is displayed at substantially the second location of the main object in the second image; and
reproducing the third image according to a reproducing region.

5. The method of claim 1, further comprising:
reproducing the first image so that the main object in the first image is displayed in a user-defined area; and
reproducing the second image so that the main object of the second image is displayed in the user-defined area.

6. The method of claim 1, further comprising:
reproducing the first image according to a reproducing region;
shifting and reproducing the second image so that the main object in the second image is displayed at substantially the first location of the main object in the first image; and
reproducing the second image according to the reproducing region.

7. The method of claim 1, further comprising:
detecting the main object;
grouping images including the main object; and
determining the first image and the second image in the group of images comprising the main object.

8. The method of claim 1, wherein the main object is a face, and further comprising:
grouping images comprising the face; and
determining the first image and the second image in the group of images.

9. An apparatus comprising:
an object location recognizer to recognize a main object of a first image and a second image;
a reproducing location adjuster to determine a reproducing location of the second image so that the main object of the second image is displayed at substantially a location of the main object of the first image; and
an image reproducing unit to reproduce the second image according to the reproducing location of the second image after reproducing the first image.

10. The apparatus of claim 9, further comprising:
an object size recognizer to recognize a first size of the main object of the first image and a second size of the main object of the second image; and
a scaling unit for scaling the second image according to the first size of the main object of the first image and the second size of the main object of the second image.

11. The apparatus of claim 9, wherein the object location recognizer is to recognize a second location of the main object of a third image, the reproducing location adjuster is to determine a second reproducing location of the third image so that the main object of the third image is displayed at substantially the location of the main object of the first image, and the image reproducing unit reproduces the third image according to the second reproducing location of the third image after reproducing the second image.

12. The apparatus of claim 9, wherein the reproducing location adjuster is to determine a second reproducing location of the first image and the reproducing location of the second image so that the main object of the first image and the main object of the second image are displayed substantially in a user-set area, and the image reproducing unit is to display the first image substantially at the second reproducing location of the first image and display the second image substantially at the reproducing location of the second image.

13. The apparatus of claim 9, wherein the image reproducing unit is to shift and reproduce the first image according to a reproducing region, to reproduce the second image according to the reproducing location of the second image, and further comprising a readjusting unit to control the second image to be reproduced according to the reproducing region.

14. The apparatus of claim 13, wherein the object location recognizer is to recognize the main object in a third image, the reproducing location adjuster to determine a third reproducing location of the third image so that the main object in the third image is displayed at substantially the location of the main object of the second image, the image reproducing unit is to shift and reproduce the third image according to the third reproducing location of the third image, and the readjusting unit is to control the third image to be reproduced according to the reproducing region.

15. The apparatus of claim 9, further comprising:
an object detector to detect the main object;
a grouping unit to group images including the main object; and
a reproducing image determining unit to determine the first image and the second image in the group of images comprising the main object.

16. The apparatus of claim 9, wherein the main object is a face, and further comprising:
an object recognizer to recognize a face detected in an image;
a grouping unit to group images comprising the face; and
a reproducing image determining unit to determine the first image and the second image in the group of images comprising the face.

17. A tangible computer-readable storage medium having embodied thereon computer program codes that, when executed, cause a machine to at least:
reproduce a first image;
recognize a first location of a main object in the first image;
recognize a second location of a main object in a second image; and
reproduce the second image so that the main object in the second image is displayed at substantially the first location of the main object in the first image.

18. The computer-readable storage medium of claim 17, wherein the program code, when executed, cause the machine to:
recognize a first size of the main object of the first image;
recognize a second size of the main object of the second image; and
scale the second image according to the first size of the main object of the first image and the second size of the main object of the second image.

19. The computer-readable storage medium of claim 17, wherein the program code, when executed, cause the machine to:
recognize a third location of the main object in a third image; and
reproduce the third image so that the main object in the third image is displayed at substantially the first location of the main object of the first image.

20. The computer-readable storage medium of claim 17, wherein the program code, when executed, cause the machine to:
reproduce the first image so that the main object in the first image is displayed in a user-defined area; and
reproduce the second image so that the main object of the second image is displayed in the user-defined area.

21. The computer-readable storage medium of claim 17, wherein the program code, when executed, cause the machine to:
reproduce the first image according to a reproducing region;
shift and reproduce the second image so that the main object in the second image is displayed at substantially the first location of the main object in the first image; and
reproduce the second image according to the reproducing region.

22. The computer-readable storage medium of claim 17, wherein the program code, when executed, cause the machine to:
detect the main object;
group images including the main object; and
determine the first image and the second image in the group of images comprising the main object.

23. The computer-readable storage medium of claim 17, wherein the main object is a face and the program code, when executed, cause the machine to:
group images comprising the face; and
determine the first image and the second image in the groups of images comprising the faces.
